(19) United States
(12) Patent Application Publication
(10) Pub. No.: US 2013/0001016 A1
(43) Pub. Date: Jan. 3, 2013

(54) O-RING LUBRICANT

(75) Inventors: Donato Polignone, Emeryville, CA (US); Fereidoun Pourmirzaie, Emeryville, CA (US); Shoeb Moiyadi, Emeryville, CA (US); Karel Schaap, Emeryville, CA (US)

(73) Assignee: NuGeneration Technologies, LLC, Emeryville, CA (US)

(21) Appl. No.: 13/173,275

(22) Filed: Jun. 30, 2011

(51) Int. Cl. F16N 3/00; C10M 131/10; C10M 131/02

(52) U.S. Cl. 184/6; 508/588; 508/582

(57) ABSTRACT

One example embodiment includes a lubricant for installing an O-ring in a groove where the lubricant cleanroom compatible. The lubricant includes a fluorinated solvent. The lubricant also includes a fluorinated oil.

### CROSS-REFERENCE TO RELATED APPLICATIONS

Not applicable.

### BACKGROUND OF THE INVENTION

Many devices and process include a fluid moving within a device. The fluid can include liquid, air or any other fluid. The device channels the movement of the fluid for a specific purpose. In many cases, the fluid is moving through a junction between two parts or between the device and an external device. At such a junction, the pressure differential can be quite high. In contrast, the junction often is weaker than the surrounding material. Therefore, the high pressure differential can cause the joint to leak or the fluid to “blow out”, with the fluid pressing out of the junction. A common way to minimize this potential for leakage is through the use of an O-ring or other gasket.

An O-ring is a torus shaped gasket. The O-ring is inserted into a groove in one or both ends of the joint. The outward fluid pressure created at the joint is converted to pressure that acts longitudinally at the joint. I.e., the outward pressure is converted to pressure which is longitudinal rather than outward and the remaining outward pressure is minimized. This decreases the chances of a joint failure dramatically.

However, the fit between the O-ring and the groove may be very tight. As a result, the O-ring is often difficult to insert into the groove. In particular, a dry O-ring experiences frictional resistance to installation and high forces may be required to install the O-ring. In addition, because of the high forces, even minor imperfections may lead to damage to the O-ring. Therefore, lubricant may be used to ease the installation of the O-ring into the groove.

Currently, however, there are few lubricant options for O-ring installation. In particular, in cleanroom applications, or other applications were residue is undesirable, there are virtually no commercially available O-ring lubricants. Most of the time user's simply apply isopropyl alcohol to the O-ring to be installed. Isopropyl alcohol has no lubricating properties; however, it evaporates completely and the wetness is assumed to add at least some lubricating ability.

Accordingly there is a need in the art for a lubricant that can be used for O-ring and gasket installation. Additionally, there is a need for the lubricant to be clean room compatible.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a lubricant for installing an O-ring in a groove where the lubricant cleanroom compatible. The lubricant includes a fluorinated solvent. The lubricant also includes a fluorinated oil.

Another example embodiment includes a system for applying a lubricant to an O-ring where the lubricant is cleanroom compatible. The system includes a wipe. The system also includes a lubricant. The lubricant is embedded in the wipe. The lubricant includes a fluorinated solvent. The lubricant also includes a fluorinated oil.

Another example embodiment includes a system for applying a lubricant to an O-ring where the lubricant is cleanroom compatible. The system includes a wipe. The system also includes a container. The wipe is located within the container. The container includes an opening, wherein the opening is configured to allow a user to access the wipe if desired. The container is configured to prevent air exchange between the interior of the container and the exterior of the container if the opening is closed. The system further includes a lubricant. The lubricant is embedded in the wipe. The lubricant includes a fluorinated solvent, wherein the fluorinated solvent vaporizes completely. The lubricant also includes a fluorinated oil. The fluorinated oil either does not vaporize or vaporizes at a low rate.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a device which will be connected to an external device;

FIG. 2 is a flowchart illustrating an example of a method for manufacturing a lubricant; and

FIG. 3 illustrates an example of a lubricant applicator.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

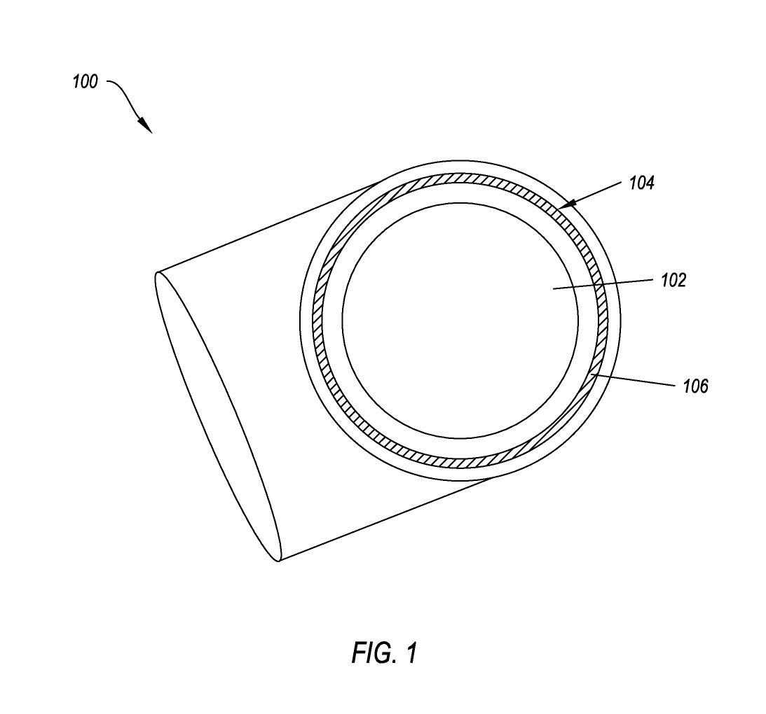

FIG. 1 illustrates an example of a device 100 which will be connected to an external device. In at least one implementation, the device 100 is any device which is configured to connect to an external device. The connection between the device 100 and the external device requires a seal. The seal may be subjected to high pressures or vacuum conditions, as described below.

FIG. 1 shows that the device 100 includes an opening 102. In at least one implementation, the opening 102 will seal to an external device. In particular, the device 102 is configured to connect to an external device, with the opening 102 directly connected to the external device. Fluid or other material can pass through the opening 102 to or from the external device.

FIG. 1 shows that the device 100 includes a groove 104. In at least one implementation, the grove 104 surrounds the opening 102. I.e., the groove 104 will be located external to, and completely surrounding, the connection between the opening 102 and the external device.

FIG. 1 also shows that the device 100 includes an O-ring 106. In at least one implementation, an O-ring 106, also known as a packing, or a toric joint, is a mechanical gasket in the shape of a torus. I.e., it is a loop of elastomer with a disc-shaped cross-section, designed to be seated in the groove 106 and compressed during assembly between two or more parts, creating a seal at the interface. In particular, the O-ring 106 can be used to ensure a tight seal between the device 100 and an external device. One skilled in the art will appreciate that while the O-ring 106 is treated as exemplary herein, the invention can be applied to any gasket or other sealing mechanism.

In at least one implementation, O-rings 106 are available in various metric and inch standard sizes. In particular, sizes are specified by the inside diameter and the cross section diameter (thickness) of the O-ring 106. Any size of O-ring 106 is contemplated for use herein unless otherwise specified in the specification or claims.

One of skill in the art will appreciate that the fit between the groove 104 and the O-ring 106 can be critical. In particular, successful O-ring 106 joint design requires a rigid mechanical mounting that applies a predictable deformation to the O-ring 106. This introduces a calculated mechanical stress at the O-ring 106 contacting surfaces. As long as the pressure of the fluid being contained does not exceed the contact stress of the O-ring 106, leaking cannot occur. However, the pressure of the contained fluid transfers through the essentially incompressible O-ring 106 material, and the contact stress rises with increasing pressure. For this reason, an O-ring 106 can easily seal high pressure as long as it does not fail mechanically.

In at least one implementation, the seal is designed to have a point contact between the O-ring 106 and sealing faces. This allows a high local stress, able to contain high pressure, without exceeding the yield stress of the O-ring 106 body. The flexible nature of O-ring 106 materials accommodates imperfections in the mounting parts. In vacuum applications, the permeability of the material makes point contacts useless. Instead, higher mounting forces are used and the O-ring 106 fills the whole groove 104. However, the tolerance between the groove 104 and the O-ring 106 is quite low, especially at low temperatures where the seal material reaches its glass transition temperature and becomes increasingly crystalline. As a result, the O-ring 106 may be difficult to install within the groove 104.

### Example of an O-Ring Lubricant

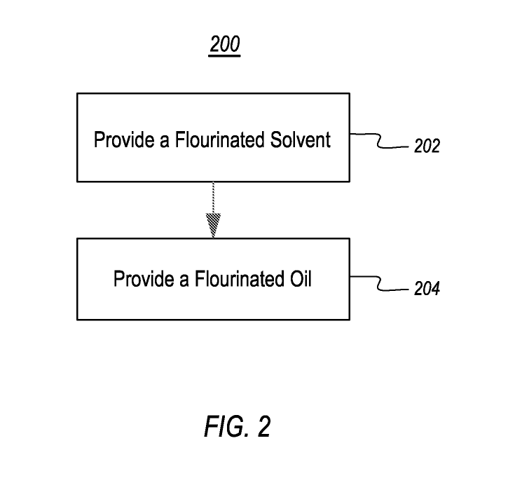

FIG. 2 is a flowchart illustrating an example of a method 200 for manufacturing a lubricant. In at least one implementation, the lubricant can be used for installing an O-ring 106 within a groove 104. In particular, the fit between the O-ring 106 and the groove 104, especially in high pressure or vacuum applications can be very tight. I.e., the O-ring 106 can be difficult to install. The lubricant can make installation easier and prevent damage to the O-ring 106 during installation. Therefore, the method 300 will be described, exemplarily, with reference to the device 100 of FIG. 1. Nevertheless, one of skill in the art can appreciate that the method 300 can be used to produce a lubricant suitable for use in devices other than the device 100 of FIG. 1.

In at least one implementation, the lubricant can be cleanroom compatible. A cleanroom is an environment, typically used in manufacturing or scientific research, which has a low level of environmental pollutants such as dust, airborne microbes, aerosol particles and chemical vapors. More accurately, a cleanroom has a controlled level of contamination that is specified by the number of particles per cubic meter at a specified particle size.

In order to be cleanroom compatible a lubricant must not leave any residue that can affect the equipment in the clean room. Specifically, all components of the lubricant either must vaporize completely or almost completely (leave no residue) or, if it leaves a residue, then the residue must not vaporize at all. A complete lack of vaporization prevents the residue from condensing on any of the components located within the cleanroom and affecting any manufacturing processes.

In addition, complete vaporization or complete lack of vaporization both prevent unseating of the O-ring 106. I.e., the lubricant vaporizes and is forced out of the groove 104 into which the O-ring 106 will be installed or remains within the groove 104 and does not affect the performance of the O-ring 106. In particular, any components which do not vaporize cannot outgas, pushing the O-ring 106 from the groove 104 and preventing an adequate seal.

FIG. 2 shows that the method 200 can include providing a fluorinated solvent 202. In at least one implementation, the fluorinated solvent can provide a base for the lubricant. I.e., the fluorinated solvent can allow the other components of the lubricant to fully dissolve and/or mix completely. The fluorinated solvent can be highly volatile, leaving behind only the other components of the lubricant after application.

One example of a fluorinated solvent includes hydrofluorocarbons (HFCs). HFCs include hydrocarbons in which one or more of the hydrogen atoms has been replaced with a fluorine atom. The carbon-fluorine bond is one of the strongest in organic chemistry and it is relatively short. Its properties reflect in part the high electronegativity of fluorine. As a result, the physical and chemical properties of HFCs can be distinctive in comparison to their related hydrocarbon. Examples of acceptable HFCs for use in a cleanroom lubricant include HFC-43-10 (also known as Vertrel XF—made by DuPont) and HFC-63-13 (made by DuPont). HFC-43-10 includes 1,1,1,2,2,3,4,5,5,5-Decafluoropentane (C₅H₂F₁₀).

Another example of a fluorinated solvent includes perfluorocarbons (PFCs). PFCs, sometimes referred to as fluorocarbons, are organofluorine compounds that contain carbon and fluorine. I.e., they are hydrocarbons in which all of the hydrogen atoms have been replaced with fluorine atoms. In general, PFCs have chemical inertness and thermal stability because of the strength of the carbon-fluorine bond and the shielding effect of the fluorine atoms. In addition, the electronegativity of fluorine reduces the polarizability of the electron clouds. This results in reduced van der Waals forces between PFCs. I.e., PFCs tend to be highly volatile. Example of acceptable PFCs include Fluorinert (made by 3M) and heat transfer (HT) Fluids made by Solvay-Galden (e.g., Fomblin). Fluorinert is line of fluorocarbon based fluids. Fluorinert can include perflurohexane (C₆H₁₄—aka FC-72), 2,2,3,3,4,4,5-heptafluoro-5-(1,1,2,2,3,3,4,4,4-nonafluorobutyl)tetrahydrofuran (C₈F₁₆O—aka FC-75) and perfluoro-tripentylamine (C₁₅F₃₃N—aka FC-70). Fomblin can include 1-Propene,1,1,2,3,3,3-hexafluoro-, oxidized, polymerized ((C₃F₆O)ₓ(CF₂O)_{y}—where x and y are the degree of polymerization).

Another example of a fluorinated solvent includes hydrofluoroethers (HFEs). HFEs are HFCs which include an ether group—an oxygen atom connected to two alkyl or aryl groups. I.e. HFEs are two or more hydrocarbons connected to one another by an oxygen atom in which one or more of the hydrogen atoms have been replaced by a fluorine atom. Examples of acceptable HFEs include HFE-7000, HFE-7100 and HFE-7200 (made by 3M). HFE-7000 includes 1,1,1,2,2,3,3-Heptafluoro-3-methoxypropane (C₄H₃F₇O—aka methyl perfluoropropyl ether). HFE-7100 includes a mixture of 1,1,1,2,2,3,3,4,4-nonafluoro-4-methoxybutane (C₅H₃F₉O—aka methyl nonafluorobutyl ether) and 2-(difluoromethoxymethyl)-1,1,1,2,3,3,3-heptafluoropropane (C₅H₃F₉O—aka methyl nonafluoroisobutyl ether). HFE-7200 includes a mixture of 1-ethoxy-1,1,2,2,3,3,4,4,4-nonafluoro-butane (C₆H₅F₉O—aka ethyl nonafluorobutyl ether) and 2-(ethoxydifluoromethyl)-1,1,1,2,3,3,3-heptafluoro-propane (C₆H₅F₉O—aka ethyl nonafluoroisobutyl ether).

FIG. 2 also shows that the method 200 can include providing a fluorinated oil 204. In at least one implementation, the fluorinated oil provides the lubrication for the installation of the O-ring 106. In particular, the lubricant is applied to the O-ring 106. The fluorinated solvent completely vaporizes, leaving only the fluorinated oil behind to lubricate the O-ring 106. In general, fluorinated oils are quite expensive. Therefore, the fluorinated solvent can be used to maximize the efficient application of fluorinated oil to the O-ring 106.

One example of a fluorinated oil includes perfluoropolyethers (PFPEs). PFPEs are polyethers in which all of the hydrogen atoms have been replaced with fluorine atoms. A polyether is a hydrocarbon with more than one ether group. The carbon chains connecting the ether groups can be of identical length to one another or can be of different length from one another. An example of an acceptable PFPE is Krytox (made by DuPont). Krytox includes polymers of polyhexafluoropropylene oxide, with a chemical formula:

F—(CF(CF₃)—CF₂—O)ₙ—CF₂CF₃

where the degree of polymerization, n, generally lies within the range of 10 to 60.

In addition to PFPE, Krytox also includes telomers of polytetrafluoroethylene (PTFE). In chemistry, PTFE is a synthetic fluoropolymer of tetrafluoroethylene that finds numerous applications. PTFE is most well-known by the DuPont brand name Teflon. Krytox is thermally stable, nonflammable (even in liquid oxygen), and insoluble in water, acids, bases, and most organic solvents. It is nonvolatile and useful over a broad temperature range of −75 to 350° C. or higher. It can also withstand extreme pressure and high mechanical stress. These properties make Krytox, and other PFPEs, cleanroom compatible.

In at least one implementation, the ratio of fluorinated solvent to fluorinated oil can be any desired ratio. In particular, the ratio can include enough fluorinated solvent to ensure that the fluorinated oil is sufficiently spread to oil it to lubricate the installation of the O-ring 106 without overly diluting the fluorinated oil. For example, the ratio of fluorinated oil to fluorinated solvent can be between 1:4.6 and 1:6.6 by volume. E.g., the ratio of fluorinated oil to fluorinated solvent can be approximately 1:5.6 by volume. In particular, the ratio of fluorinated oil to fluorinated solvent can be approximately 1:5.64 by volume. As used in the specification and the claims, the term approximately shall mean that the value is within 10% of the stated value, unless otherwise specified.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

### Examples of a Lubricant Applicator

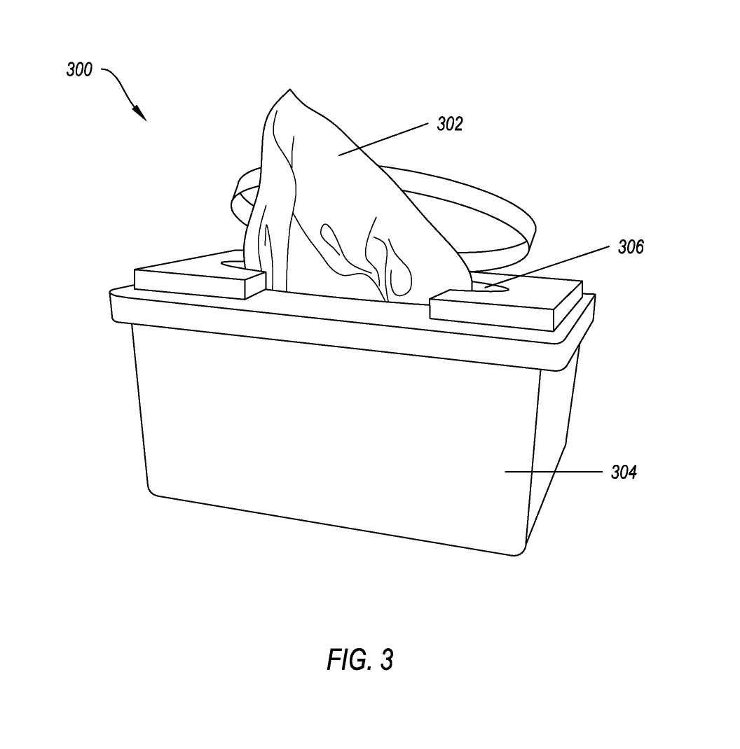

FIG. 3 illustrates an example of a lubricant applicator 300. In at least one implementation, the lubricant applicator 300 makes it easier for a user to apply the lubricant. In particular, the lubricant applicator provides a predetermined amount of lubricant, which the user can then apply to the area needed.

FIG. 3 shows that the lubricant applicator 300 can include a wipe 302. In at least one implementation, the wipe 302 can include a fabric embedded with the lubricant which can be wiped on the O-ring. The wipe 302 can include a disposable wipe. For example, the wipe 302 can include a facial tissue. Facial tissue, also called a paper handkerchief, refers to a class of soft, absorbent, disposable papers that is suitable for use on the face. The terms are commonly used to refer to the type of paper tissue, usually sold in boxes, that is designed to facilitate the expulsion of nasal mucus from the nose, and other wipes such as napkins. Facial tissue is often referred to as a “tissue”, or by the genericized trademark “Kleenex” which popularized the invention and its use.

Additionally or alternatively, the wipe 302 can include a fabric. In at least one implementation, the fabric can include any network of natural or artificial fibers including textiles and cloth. In at least one implementation, the fibers can include thread or yarn. For example, yarn can be produced by spinning raw wool fibers, linen, cotton, or other material on a spinning wheel to produce long strands. The fabric can be formed by weaving, knitting, crocheting, knotting, or pressing fibers together, such as in felt. One of skill in the art will appreciate that the fabric can include a single fiber or more than one fibers.

FIG. 3 also shows that the applicator 300 can include a container 304. In at least one implementation, the container 304 is configured to be air tight. In particular, the container 304, when closed, can prevent the exchange of gas with the exterior of the container 304. This can prevent the evaporation of the volatile fluorinated solvent. I.e., the container 304 can allow the wipes 302 to be removed when needed for use but preserve the lubricant when not in use.

FIG. 3 further shows that the applicator 300 can include an opening 306. In at least one implementation, the opening 306 can allow a user to retrieve a wipe 302 when desired. In particular, the wipes 302 can be folded onto one another, such that when a first wipe 302 is removed from the container 304 a portion of a second wipe 302 extends from the opening 306, allowing the user to pull out the second wipe 302 when desired.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A lubricant for installing an O-ring in a groove, wherein the lubricant is cleanroom compatible, the lubricant comprising:
a fluorinated solvent; and
a fluorinated oil.

2. The system of claim 1, wherein the fluorinated solvent includes a hydroflurocarbon.

3. The system of claim 2, wherein the hydrofluorocarbon include Vertrel XF.

4. The system of claim 1, wherein the fluorinated solvent includes a perfluorocarbon.

5. The system of claim 4, wherein the perfluorocarbon include Fluorinert.

6. The system of claim 4, wherein the perfluorocarbon include Fomblin.

7. The system of claim 1, wherein the fluorinated solvent includes a hydrofluoroether.

8. The system of claim 7, wherein the hydrofluoroether includes one of:
HFE-7000;
HFE-7100; or
HFE-7200

9. The system of claim 1, wherein the fluorinated oil includes a perfluoropolyether.

10. The system of claim 9, wherein the perfluoropolyether includes telomers of polytetrafluoroethylene.

11. The system of claim 10, wherein the perfluoropolyether includes Krytox.

12. A system for applying a lubricant to an O-ring wherein the lubricant is cleanroom compatible, the system comprising:
a wipe; and
a lubricant, wherein the lubricant:
is embedded in the wipe; and
includes:
a fluorinated solvent; and
a fluorinated oil.

13. The system of claim 12, wherein the ratio of fluorinated oil to fluorinated solvent is between 1:4.6 and 1:6.6 by volume.

14. The system of claim 13, wherein the ratio of fluorinated oil to fluorinated solvent is approximately 1:5.6 by volume.

15. The system of claim 14, wherein the ratio of fluorinated oil to fluorinated solvent is approximately 1:5.64 by volume.

16. A system for applying a lubricant to an O-ring wherein the lubricant is cleanroom compatible, the system comprising:
a wipe;
a container, wherein:
the wipe is located within the container;
the container includes an opening, wherein the opening is configured to allow a user to access the wipe if desired; and
the container is configured to prevent air exchange between the interior of the container and the exterior of the container if the opening is closed; and
a lubricant, wherein the lubricant:
is embedded in the wipe; and
includes:
a fluorinated solvent, wherein the fluorinated solvent vaporizes completely; and
a fluorinated oil, wherein the fluorinated oil either:
does not vaporize; or
vaporizes at a low rate.

17. The system of claim 16 further comprising a second wipe, wherein:
the second wipe is located within the container; and
the lubricant is embedded in the second wipe.

18. The system of claim 17, wherein the first wipe and the second wipe are folded such that removal of the first wipe from the container removes at least a portion of the second wipe from the container.

19. The system of claim 16, wherein the wipe includes a paper tissue.

20. The system of claim 16, wherein the wipe includes a fabric.
